(19) United States
(12) Patent Application Publication
(10) Pub. No.: US 2021/0221955 A1
(43) Pub. Date: Jul. 22, 2021

(54) METHOD OF MAKING A THREE-DIMENSIONAL OBJECT USING A POLY(ARYL ETHER SULFONE) (PAES) POLYMER OF LOW POLYDISPERSITY

(71) Applicant: SOLVAY SPECIALTY POLYMERS USA, LLC, Alpharetta, GA (US)

(72) Inventors: Stéphane JEOL, Saint-Genis Laval (FR); Nancy J. SINGLETARY, Alpharetta, GA (US); Vito LEO, Glimes (Incourt) (BE)

(21) Appl. No.: 17/055,224

(22) PCT Filed: May 16, 2019
(86) PCT No.: PCT/EP2019/062719

§ 371 Date: Nov. 13, 2020

Related U.S. Application Data
(60) Provisional application No. 62/672,764, filed on May 17, 2018.

(30) Foreign Application Priority Data
Jun. 19, 2018 (EP) 18178633.6

(51) Int. Cl. C08G 75/23; B33Y 70/00; C08G 65/40

(52) U.S. Cl. CPC C08G 75/23; B29C 64/118; C08G 65/4056; B33Y 70/00

(57) ABSTRACT

The present disclosure relates to a method for manufacturing a three-dimensional (3D) object with an additive manufacturing system, comprising a step consisting in printing layers of the three-dimensional object from the part material comprising a polymeric component comprising at least one poly(aryl ether sulfone) (PAES) polymer having a number average molecular weight (Mn) of at least 12,000 g/mol and a polydispersity (PDI) of less than 1.7. The present invention also relates to polymeric filaments comprising such a PAES, as well as to the use of this PAES to prepare filaments and to print 3D objects.

### RELATED APPLICATIONS

This application claims priority to U.S. No. 62/672,764 filed on May 17, 2018 and to EP No. 18178633.6 filed on Jun. 19, 2018, the whole content of each of these applications being incorporated herein by reference for all purposes.

### TECHNICAL FIELD

The present disclosure relates to a method for manufacturing a three-dimensional (3D) object with an additive manufacturing system, comprising a step consisting in printing layers of the three-dimensional object from the part material comprising a polymeric component comprising at least one poly(aryl ether sulfone) (PAES) polymer having a number average molecular weight (Mn) of at least 12,000 g/mol and a polydispersity index (PDI) of less than 1.7. The present invention also relates to polymeric filaments comprising such a PAES, as well as to the use of this PAES to prepare filaments and to print 3D objects.

### BACKGROUND ART

Additive manufacturing systems are used to print or otherwise build 3D parts from digital representations of the 3D parts using one or more additive manufacturing techniques. Examples of commercially available additive manufacturing techniques include extrusion-based techniques, selective laser sintering, powder/binder jetting, electron-beam melting and stereolithography processes. For each of these techniques, the digital representation of the 3D part is initially sliced into multiple horizontal layers. For each sliced layer, a tool path is then generated, which provides instructions for the particular additive manufacturing system to print the given layer.

For example, in an extrusion-based additive manufacturing system, a 3D part may be printed from a digital representation of the 3D part in a layer-by-layer manner by extruding and adjoining strips of a part material. The part material is extruded through an extrusion tip carried by a print head of the system, and is deposited as a sequence of roads on a platen in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation. An example of extrusion-based additive manufacturing system starting from filaments is called Fused Filament Fabrication (FFF).

As another example, in a powder-based additive manufacturing system, a powerful laser is used to locally sinter powder into a solid part. A 3D part is created by sequentially depositing a layer of powder followed by a laser pattern to sinter an image onto that layer. An example of powder-based additive manufacturing system starting from powder is called Selective Laser Sintering (SLS).

Multi jet fusion (“MJF”) is another example of an additive manufacturing printing method. During multi jet fusion, the entire layer of the powdered material is exposed to radiation, but only a selected region is fused and hardened to become a layer of a 3D object. The MJF method makes use of a fusing agent, which has been selectively deposited in contact with the selected region of the powdered material. The fusing agent is capable of penetrating into the layer of the powdered material and spreading onto the exterior surface of the powdered material. The fusing agent is capable of absorbing radiation and converting the absorbed radiation to thermal energy, which in turn melts or sinters the powdered material that is in contact with the fusing agent. This causes the powdered material to fuse, bind, cure, in order to form a layer of the 3D object.

As another example yet, carbon-fiber composites 3D part can be prepared using the continuous Fiber-Reinforced Thermosplastic (FRTP) printing method. The printing is based on fused-deposition modeling (FDM) and combines fibers and resin in a nozzle.

One of the fundamental limitations associated with known additive manufacturing methods is based on the lack of identification of a polymeric material which allows obtaining a resulting 3D part with acceptable mechanical properties.

There is therefore a need for polymeric part material to be used in additive manufacturing systems, for example FFF, SLS, MJF or FRTP printing methods, which make possible the manufacture of 3D objects presenting improved mechanical properties (e.g. impact resistance).

There is also a need for polymeric part material which can be easily be processed into filaments for use in extrusion-based 3D printing process, at a temperature which is as low as possible, in order to positively impact the energy consumption not only to prepare the material to be printed, but also the temperature of the 3D printing process.

US 2015/322209 A1 relates to a PAES of low dispersity and describes methods of producing more narrowly dispersed PAES, which do not employ a metal catalyst and do not produce a cyclic byproduct. The PAES polymer described in this patent application necessarily contains electron withdrawing groups (nitro, cyano, triF . . . ).

US 2008/160378 A1 relates to a pyridine-containing polyarylene ether (PAE), obtained by reacting one or more aromatic pyridine monomers with one or more aromatic difluoride compounds.

CN 106565957 A describes a method to prepare a polyether sulfone polymer of low polydispersity and with a Mn higher than 12,000g/mol. This document does not describe the use of such polymers for 3D printing or filaments of PES.

None of these documents describe a method for manufacturing a 3D object with an AM system, with the part material comprising a polymeric component comprising at least one poly(aryl ether sulfone) (PAES) polymer having a number average molecular weight (Mn) of at least 12,000 g/mol and a polydispersity index (PDI) of less than 1.7.

### SUMMARY OF INVENTION

An aspect of the present invention is directed to a method for manufacturing a three-dimensional (3D) object with an additive manufacturing system, comprising a step consisting in printing layers of the three-dimensional object from the part material comprising a polymeric component comprising at least one poly(aryl ether sulfone) (PAES) polymer having a number average molecular weight (Mn) of at least 12,000 g/mol and a polydispersity index (PDI) of less than 1.7.

The 3D objects or articles obtainable by such method of manufacture can be used in a variety of final applications. Mention can be made in particular of implantable device, dental prostheses, brackets and complex shaped parts in the aerospace industry and under-the-hood parts in the automotive industry.

According to an embodiment, the method also includes the extrusion of the part material, with an extrusion-based additive manufacturing system, also known as fused filament fabrication technique (FFF).

Another aspect of the disclosure is directed to a filament material comprising a polymeric component comprising at least one poly(aryl ether sulfone) (PAES) polymer having a number average molecular weight (Mn) of at least 12,000 g/mol and a polydispersity index (PDI) of less than 1.7.

Another aspect yet of the present disclosure is directed to the use of the herein described part material for the manufacture of three-dimensional objects or for the manufacture of a filament for use in the manufacture of three-dimensional objects using an additive manufacturing system, for example FFF, SLS or FRTP printing methods.

The applicant has found that the use of a poly(aryl ether sulfone) (PAES) polymer having a specific number average molecular weight (Mn) and an altered molecular weight distribution for 3D printing an object, allows the manufacture of 3D objects presenting an improved impact resistance. The

Applicant also shows that such PAES polymer can be processed into filaments for extrusion-based 3D printing process at a much lower temperature, which reduces the energy consumption needed to prepare the material to be printed.

### DESCRIPTION OF EMBODIMENTS

The present disclosure relates to a method of making or manufacturing a three-dimensional (3D) object using an additive manufacturing system, such as an extrusion-based additive manufacturing system (for example FFF), a powder-based additive manufacturing system (for example SLS) or a continuous Fiber-Reinforced Thermosplastic (FRTP) printing method.

The method of the present disclosure comprises the step of printing layers of the 3D object from the part material comprising a polymeric component comprising at least one poly(aryl ether sulfone) (PAES) polymer having a number average molecular weight (Mn) of at least 12,000 g/mol and a polydispersity (PDI) of less than 1.7.

According to an embodiment, the method of the present disclosure comprises the step of extruding a part material in the form of a filament, the filament comprising a polymeric component which comprises at least one poly(aryl ether sulfone) (PAES) polymer having a number average molecular weight (Mn) of at least 12,000 g/mol and a polydispersity index (PDI) of less than 1.7, in order to print layers of the 3D object from the part material.

According to an embodiment, the method of the present disclosure comprises the step of selectively sintering a part material in the form of a powder material, the powder material comprising a polymeric component which comprises at least one poly(aryl ether sulfone) (PAES) polymer having a number average molecular weight (Mn) of at least 12,000 g/mol and a polydispersity index (PDI) of less than 1.7, in order to print layers of the 3D object from the part material. In this case, the powder can have a regular shape such as a spherical shape, or a complex shape obtained by grinding/milling of pellets or coarse powder.

The merit of the applicant has been to surprisingly identify a sulfone polymer, which allows the manufacture of 3D objects having an improved impact resistance, while at the same time lowering the processing temperature to prepare filaments of material. This sulfone polymer is a poly(aryl ether sulfone) (PAES) polymer having a number average molecular weight (Mn) of at least 12,000 g/mol and a polydispersity index (PDI) of less than 1.7, for example a Mn from 12,000 and 20,000 g/mol and/or a PDI less than 1.6, or less than 1.5.

It is generally known and described in the literature that materials used for FFF or FDM must have a melt viscosity as low as possible in order to be extruded in a continuous way at the extrusion temperature. Also the melt viscosity of the polymers must be low enough so that deposited filaments lay flat rather than curl up. Melt viscosity can be lowered by increasing the temperature at which the material is extruded, but a too high temperature can cause heated material to decompose and increases energy consumption. Decreasing the molecular weight is another way to lower the melt viscosity; however polymeric material of too low molecular weight may be difficult to process into filaments, due to brittleness of the polymer. Polymers of low melt viscosity must not only provide 3D printed articles presenting good mechanical properties, but they must also be easily processable into filaments materials when they are used in extrusion-based 3D printing methods.

The temperature used for preparing the polymeric filaments of low melt viscosity can advantageously be reduced, as well as the temperature set up for printing the 3D objects, which positively impacts the energy consumption and broaden the range of printers which can be used.

The Applicant hereby shows that using a PAES of low PDI in a 3D printing process allows to significantly lowering the extrusion temperature used to prepare the filaments. The Applicant also shows that the printing properties of the material are maintained, while at the same time improving the impact resistance of the final article.

The expressions “(co)polymer” or “polymer” are hereby used to designate homopolymers containing substantially 100 mol. % of the same recurring units and copolymers comprising at least 50 mol. % of the same recurring units, for example at least about 60 mol. %, at least about 65 mol. %, at least about 70 mol. %, at least about 75 mol. %, at least about 80 mol. %, at least about 85 mol. %, at least about 90 mol. %, at least about 95 mol. % or at least about 98 mol. %.

The expression “part material” hereby refers to a blend of material, notably polymeric compounds, intended to form at least a part of the 3D object. The part material is according to the present disclosure used as feedstocks to be used for the manufacture of 3D objects or part of 3D objects.

The method of the present disclosure indeed employs a PAES polymer (also called sulfone polymer), which can be the main element of the part material and which can for example be shaped in the form of a filament or microparticles (with a regular shape such as spheres, or with a complex shape obtained by grinding/milling of pellets), to build a 3D object (e.g. a 3D model, a 3D article or a 3D part).

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

According to an embodiment, the part material is in the form of a filament. The expression “filament” refers to a thread-like object or fiber formed of a material or blend of materials which according to the present disclosure comprises at least a PAES polymer of specific Mn and PDI.

The filament may have a cylindrical or substantially cylindrical geometry, or may have a non-cylindrical geometry, such as a ribbon filament geometry; further, filament may have a hollow geometry, or may have a core-shell geometry, with another polymeric composition, being used to form either the core or the shell.

According to another embodiment, the part material is in the form of microparticles or in powder form, for example having a size comprised between 1 and 200 μm, for example between 10 and 100 μm or between 20 and 80 μm, for example for being fed through a blade, a roll or an auger-pump print head.

According to an embodiment of the disclosure, the method of manufacturing a three-dimensional object using an additive manufacturing system comprises a step consisting in extruding the part material. This step may for example occurs when printing or depositing strips or layers of part material. The method of making 3D objects using an extrusion-based additive manufacturing system is also known as fused filament fabrication technique (FFF).

FFF 3D printers are, for example, commercially available from Apium, from Hyrel, from Roboze, from NVBots, from AON3D or from Stratasys, Inc. (under the trade name Fortus®).

SLS 3D printers are, for example, available from EOS Corporation under the trade name EOSINT®P.

MJF 3D printers are, for example, available from Hewlett-Packard Company under the trade name HP Jet Fusion 3D.

FRTP 3D printers are, for example, available from Markforged.

Part Material

The part material employed in the method of the present disclosure comprises a polymeric component which comprises at least one poly(aryl ether sulfone) (PAES) polymer having a number average molecular weight (Mn) of at least 12,000 g/mol and a polydispersity index (PDI) of less than 1.7.

The part material of the invention may include other components. For example the part material may comprise at least one additive, notably at least one additive selected from the group consisting of fillers, colorants, lubricants, plasticizers, stabilizers, flame retardants, nucleating agents, flow enhancers and combinations thereof. Fillers in this context can be reinforcing or non-reinforcing in nature.

The part material may for example comprise up to 30 wt. % of at least one additive, based on the total weight of the part material.

In embodiments that include fillers (F), the concentration of the fillers in the part material ranges from 0.1 wt. % to 30 wt. %, preferentially from 0.5 to 25 wt. %, even more preferentially from 1 to 20 wt. % with respect to the total weight of the part material. Suitable fillers include calcium carbonate, magnesium carbonate, glass fibers, graphite, carbon black, carbon fibers, carbon nanotubes, graphene, graphene oxide, fullerenes, talc, wollastonite, mica, alumina, silica, titanium dioxide, kaolin, silicon carbide, zirconium tungstate, boron nitride and combinations thereof.

According to an embodiment of the present invention, the part material of the present invention comprises flame retardants such as halogen and halogen free flame retardants.

According to another embodiment of the present invention, the part material comprises at least one additive selected from the group consisting of hydroxyapatite, α-tricalcium phosphate (α-TCP), β-TCP and barium sulfate (BaSO₄).

According to another embodiment of the present invention, the part material of the present invention comprises a flow agent, also called sometimes flow aid. This flow agent may for example be hydrophilic. Examples of hydrophilic flow aids are inorganic pigments notably selected from the group consisting of silicas, aluminas and titanium oxide. Mention can be made of fumed silica.

Fumed silicas are commercially available under the trade name Aerosil® (Evonik) and Cab-O-Sil® (Cabot).

According to an embodiment of the present invention, the part material comprises from 0.01 to 10 wt. %, preferably from 0.05 to 5 wt. %, more preferably from 0.25 to 1 wt. % of a flow agent, for example of fumed silica.

These silicas are composed of nanometric primary particles (typically between 5 and 50 nm for fumed silicas). These primary particles are combined to form aggregates. In use as flow agent, silicas are found in various forms (elementary particles and aggregates).

According to one embodiment, the part material of the present disclosure comprises:
a polymeric component comprising at least one poly(aryl ether sulfone) (PAES) polymer having a number average molecular weight (Mn) of at least 12,000 g/mol and a polydispersity index (PDI) of less than 1.7, and
from 0 to 30 wt. % of at least one additive, for example selected from the group consisting of fillers, colorants, lubricants, plasticizers, flame retardants, nucleating agents, flow enhancers and stabilizers, based on the total weight of the part material.

According to another embodiment, the part material of the present disclosure consists essentially of:
a polymeric component comprising at least one poly(aryl ether sulfone) (PAES) polymer having a number average molecular weight (Mn) of at least 12,000 g/mol and a polydispersity (PDI) of less than 1.7, and
from 0 to 30 wt. %, from 0.1 to 28 wt. % or from 0.5 to 25 wt. % of at least one additive selected from the group consisting of fillers, colorants, lubricants, plasticizers, flame retardants, nucleating agents, flow enhancers and stabilizers, based on the total weight of the part material.

Poly(Aryl Ether Sulfone) (PAES)

The PAES of the part material employed in the present invention is characterized in that:
its number average molecular weight (Mn) is at least 12,000 g/mol, for example at least 12,500 or at least 13,000 g/mol, and
its PDI is less than 1.7, for example less than 1.6 or less than 1.5, wherein:
   Mn is calculated by the following formula:

$$Mn = \frac{2 , 000 , 000}{{\sum }_{i} [ {EG}_{i} ]}$$

wherein [EGᵢ] is the concentration of end-groups of the PAES in μmol/g,
Mw is calculated by GPC with light scattering according to the ASTM D-4001-93, and
PDI is Mw/Mn.

The Mn of the PAES of the present invention is determined by the end groups method. The end groups are moieties at respective ends of the PAES polymer chain that are used to assess the Mn of the PAES polymer—in particular, by measuring the concentration of the end groups to determine the number of moles of PAES in a given weight of sample.

Depending on the method used for preparing the PAES, and the possible use of an end-capping agent during the process, the PAES may possess, for example, end-groups derived from the monomers and/or from end-capping agents.

As explained below, the PAES of the invention can for example be manufactured by condensation of at least one aromatic dihydroxy monomer (a1) with at least one aromatic sulfone monomer (a2) comprising at least two halogen substituents, for example Cl or F. In this case, the end groups of the PAES may include:
hydroxyl groups,
hydroxyl groups converted into alkoxy (e.g. methoxy) or aryloxy end groups when an end-capping agent is used, and
halo-groups, such as chlorinated end groups or fluorinated end groups.

In this case therefore, the determination of the Mn of the PAES will include:
the determination of the concentration of hydroxyl groups, for example by titration,
the determination of the concentration of alkoxy or aryloxy groups, for example by NMR with a C₂D₂Cl₄ solvent, and
the determination of the concentration of halogen groups, for example using a halogen analyzer.

Generally, any suitable method may be used to determine the concentration of the end groups.

The use of the end-group method to measure the Mn of the polymer is well-suited to obtain an accurate Mn value, and then of a meaningful PDI. The method is based on titration of the molecules present in the analysed sample, based on their end-groups, independently from the size of the molecules in the sample. The Mn determined according to this method is known to be more accurate than any other methods, for example the determination of Mn by GPC.

The weight average molecular weight (Mw) of the PAES of the present invention is determined by GPC with light scattering according to the ASTM D-4001-93.

According to an embodiment of the present invention, the Mw of the PAES is less than 25,000 g/mol, for example less than 24,500 g/mol, less than 24,000 g/mol, less than 23,500 g/mol, less than 23,000 g/mol and even less than 22,000 g/mol, determined by GPC with light scattering according to the ASTM D-4001-93.

The PAES polymer of the present invention is also characterized by its polydispersity index (“PDI” or “PDI index” herewith), also called sometimes polymolecularity index. The PDI index corresponds to the molar weight distribution of the various macromolecules within the polymer. The PDI index corresponds to the ratio Mw/Mn, the Mn and Mw molecular weights being determined by as detailed above.

According an embodiment of the present invention, the polymeric component of the part material comprises at least one poly(aryl ether sulfone) (PAES), for example at least 60 wt. % (based on the total weight of the polymeric component in the part material) of at least one PAES, at least 70 wt. %, at least 80 wt. % or at least 90 wt. % of at least one PAES having:
a number average molecular weight (Mn) of at least 12,000 g/mol, for example at least 12,500 or at least 13,000 g/mol, and
a PDI of less than 1.7, for example less than 1.6 or less than 1.5.

According to another embodiment of the present invention, the polymeric component of the part material consists essentially in one PAES having:
a number average molecular weight (Mn) of at least 12,000 g/mol, for example at least 12,500 or at least 13,000 g/mol, and
a PDI of less than 1.7, for example less than 1.6 or less than 1.5.

According to yet another embodiment of the present invention, the polymeric component of the part material comprises:
a) at least one PAES having:
a number average molecular weight (Mn) of at least 12,000 g/mol, for example at least 12,500 or at least 13,000 g/mol, and
a PDI of less than 1.7, for example less than 1.6 or less than 1.5, and
b) at least one other aromatic polymer, for example selected from the group consisting of poly(aryl ether ketone) polymer (PAEK) and poly(ether imide) polymer (PEI).

For the purpose of the present invention, a “poly(aryl ether sulfone) (PAES)” denotes any polymer comprising recurring units (R_{PAES}) of formula (K):

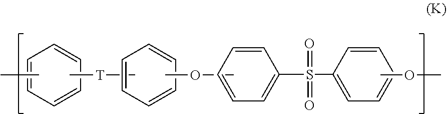

where
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6.

Preferably, R′ and R″, independently from each other, is a hydrogen, a C1-C12-alkyl, C1-C12-alkoxy, or C6-C18-aryl group. R′ and R″, are even more preferably methyl groups.

Preferably, in formula (K) above, T is a bond or —C(CH₃)₂—.

According to an embodiment of the present invention, at least 50 mol. %, at least 60 mol. %, at least 70 mol. %, at least 80 mol. %, at least 90 mol. %, at least 95 mol. %, at least 99 mol. % or all of the recurring units in the PAES are recurring units (R_{PAES}) of formula (K) or formula (K′).

According to an embodiment, the PAES has a Tg ranging from 160° C. to 250° C., preferably from 170° C. to 240° C., more preferably from 180° C. to 230° C., as measured by differential scanning calorimetry (DSC) according to ASTM D3418.

According to an embodiment, the poly(aryl ether sulfone) (PAES) is a poly(biphenyl ether sulfone) (PPSU).

A poly(biphenyl ether sulfone) polymer is a polyarylene ether sulfone which comprises a biphenyl moiety. Poly(biphenyl ether sulfone) is also known as polyphenyl sulfone (PPSU) and for example results from the condensation of 4,4′-dihydroxybiphenyl (biphenol) and 4,4′-dichlorodiphenyl sulfone.

For the purpose of the present invention, a poly(biphenyl ether sulfone) (PPSU) denotes any polymer comprising recurring units (R_{PPSU}) of formula (L):

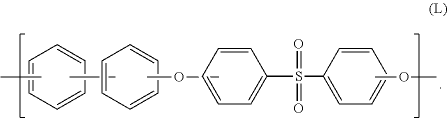

According to another embodiment, the recurring units (R_{PPSU}) are units of formula (L′):

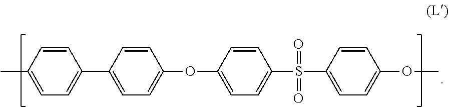

The PPSU polymer of the present invention can be a homopolymer or a copolymer. If it is a copolymer, it can be a random, alternate or block copolymer.

According to an embodiment of the present invention, at least 50 mol. %, at least 60 mol. %, at least 70 mol. %, at least 80 mol. %, at least 90 mol. %, at least 95 mol. %, at least 99 mol. % or all of the recurring units in the PPSU are recurring units (R_{PPSU}) of formula (L) and/or (L′).

When the poly(biphenyl ether sulfone) (PPSU) is a copolymer, it can be made of recurring units (R*_{PPSU}), different from recurring units (R_{PPSU}), such as recurring units of formula (M), (N′) and/or (O):

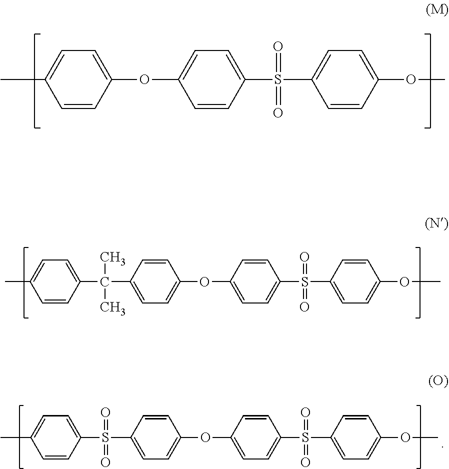

The poly(biphenyl ether sulfone) (PPSU) can also be a blend of a PPSU homopolymer and at least one PPSU copolymer, as described above.

According to the present invention, the polymeric component of the part material comprises at least one poly(biphenyl ether sulfone) (PPSU), for example at least 60 wt. % (based on the total weight of the polymeric component in the part material) of at least one PPSU, at least 70 wt. %, at least 80 wt. % or at least 90 wt. % of at least one PPSU having:
a number average molecular weight (Mn) of at least 12,000 g/mol, for example at least 12,500 or at least 13,000 g/mol, and
a PDI of less than 1.7, for example less than 1.6 or less than 1.5.

According to an embodiment, the poly(aryl ether sulfone) (PAES) is a polysulfone (PSU) polymer.

For the purpose of the present invention, a polysulfone (PSU) denotes any polymer comprising recurring units (R_{PSU}) of formula (N):

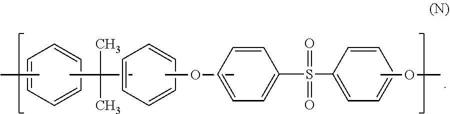

According to another embodiment, a polysulfone (PSU) denotes any polymer comprising recurring units (_{PSU}) of formula (N′) :

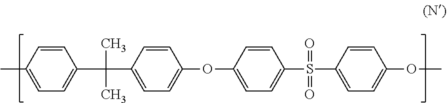

the mol. % being based on the total number of moles in the polymer.

The PSU polymer of the present invention can be a homopolymer or a copolymer. If it is a copolymer, it can be a random, alternate or block copolymer.

According to an embodiment of the present invention, at least 50 mol. %, at least 60 mol. % (based on the total number of moles in the polymer), at least 70 mol. %, at least 80 mol. %, at least 90 mol. %, at least 95 mol. %, at least 99 mol. % or all of the recurring units in the PSU are recurring units (R_{PSU}) of formula (N) and/or (N′).

When the polysulfone (PSU) is a copolymer, it can be made of recurring units (R*_{PSU}), different from recurring units (R_{PSU}), such as recurring units of formula (L′), (M) and/or (O) above described.

The polysulfone (PSU) can also be a blend of a PSU homopolymer and at least one PSU copolymer, as described above.

According to the present invention, the polymeric material comprises at least one polysulfone) (PSU), for example at least 60 wt. % (based on the total weight of the polymeric component in the part material) of at least one PSU, at least 70 wt. %, at least 80 wt. % or at least 90 wt. % of at least one PSU having:
a number average molecular weight (Mn) of at least 12,000 g/mol, for example at least 12,500 or at least 13,000 g/mol, and
a PDI of less than 1.7, for example less than 1.6 or less than 1.5.

According to an embodiment, the poly(aryl ether sulfone) (PAES) is a polyethersulfone (PES) polymer.

As used herein, a “polyethersulfone (PES)” denotes any polymer comprising recurring units are recurring units of formula (O):

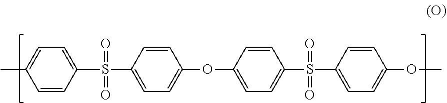

According to an embodiment, at least 50 mol. %, at least 60 mol. %, 70 mol. %, 80 mol. %, 90 mol. %, 95 mol. %, 99 mol. %, and most preferably all of the recurring units in the PES are recurring units of formula (O).

Process to Prepare the PAES of the Invention

The PAES of the present invention can be prepared by any process available to the skilled person in the art.

The PAES of the present invention may, for example, be prepared according to the following steps:
(a) preparing a PAES by condensation of at least one aromatic dihydroxy monomer (a1), with at least one aromatic sulfone monomer (a2) comprising at least two halogen substituents,
(b) dissolving the PAES obtained in step (a) in a polar solvent S_{A},
(c) adding a non-solvent S_{B} that is miscible with S_{A} for example in a weight ration S_{A}/S_{B} ranging from 50/50 to 80/20 over a period of time sufficient to create two distinct phases,
(d) separating the phases and recovering the PAES, for example by coagulation or by devolatilization.

Step (a)

Step (a) consists in preparing a PAES by condensation. The molecular weight of the PAES obtained under step (a) is not limited.

According to an embodiment however, the PAES of step (a) has a Mn of at least 8,000 g/mol, for example at least 10,000 g/mol or at least 13,000 g/mol. A modified Carothers equation:

$$Dp = \frac{1 + r}{1 - r}$$

where

Dₚ=degree of polymerization and

r=monomer ratio (a1):(a2) or (a2):(a1), with r<1

provides a means to calculate the monomer ratio (a1):(a2) necessary to produce the desired molecular weight Mn. Another option to produce a PAES of a desired Mn is to stop the reaction after the desired Mn has been attained, using an activated aromatic halide or an aliphatic halide such as methyl chloride or benzyl chloride, and the like.

The terminal hydroxyl groups of the polymer thereby convert into ether groups which stabilize the polymer for melt processing. Suitable end groups in the polycondensates are all chemically inert groups. To introduce the end groups, a small amount of an appropriate compound is introduced into the polycondensation mixture, advantageously after the desired degree of polycondensation has been reached. The use of aliphatic and aromatic halide, especially methyl chloride, is preferred. Another option yet to produce a PAES of a desired Mn is to extend the condensation reaction time until the desired Mn has been attained. Another option to produce a PAES of a desired Mn is to introduce at the beginning of the reaction a determined quantity of a monofunctional monomer containing a hydroxyl or halogen (Cl or F), for example phenol, 4-phenylphenol, 4-chlorophenyl phenyl sulfone.

The condensation of step (a) may be carried out in a solvent or the condensation of step (a) can be solvent-free, that-is-to-say can be conducted in the melt, in the absence of a solvent.

When the condensation step (a) is solvent-free, the reaction can be carried out in equipment made from materials inert toward the monomers. In this case, the equipment is chosen in order to provide enough contact of the monomers, and in which the removal of volatile reaction products is feasible. Suitable equipment includes agitated reactors, extruders and kneaders, for example mixing kneaders from List AG or BUSS. The use of mixing kneaders may notably be useful to prepare a solvent-free PAES for reasons of the residence time which can be longer than in an extruder. The equipment may for example be operated at:
a shear rate (i.e. velocity gradient in the kneading material in the gap between the rotating kneading element and the wall) in the range from 5 to 500 S⁻¹, preferably from 10 to 250 S⁻¹, in particular from 20 to 100 S⁻¹, and
a fill level (i.e. the proportion that is filled by the starting monomers of the volume capacity in the kneader which can be filled with monomers and which permits mixing) in the range from 0.2 to 0.8, preferably from 0.22 to 0.7, in particular from 0.3 to 0.7, specifically from 0.35 to 0.64.

When the condensation step (a) is carried out in a solvent, the solvent is for example a polar aprotic solvent selected from the group consisting of N-methylpyrrolidone (NMP), N,Ndimethylformamide (DMF), N,N-dimethylacetamide (DMAC), 1,3-dimethyl-2-imidazolidinone, tetrahydrofuran (THF), dimethyl sulfoxide (DMSO), chlorobenzene and sulfolane. The condensation of step (a) is preferably carried out in sulfolane or NMP.

The condensation of step (a) may be carried out in the presence of a base, for example selected from the group consisting of potassium carbonate (K₂CO₃), potassium tert-butoxide, sodium hydroxide (NaOH), potassium hydroxide (KOH), sodium carbonate (Na₂CO₃), cesium carbonate (Cs₂CO₃) and sodium tert-butoxide. The base acts to deprotonate the component (a1) during the condensation reaction.

The condensation of step (a) is preferably carried out in the presence of sodium hydroxide (NaOH), potassium carbonate (K₂CO₃), sodium carbonate (Na₂CO₃) or a blend of both of potassium carbonate (K₂CO₃) and sodium carbonate (Na₂CO₃). According to an embodiment, the condensation of step (a) is carried out in the presence of a low particle size alkali metal carbonate, for example comprising anhydrous K₂CO₃, having a volume-averaged particle size of less than about 100 μm, for example less than 50 μm, less than 30 μm or less than 20 μm.

The molar ratio (a1):(a2) may be from 0.9 to 1.1, for example from 0.92 to 1.08 or from 0.95 to 1.05.

According to an embodiment, the monomer (a2) is a 4,4-dihalosulfone comprising at least one of a 4,4′-dichlorodiphenyl sulfone (DCDPS) or 4,4′-difluorodiphenyl sulfone (DFDPS), preferably DCDPS.

According to an embodiment, the monomer (a1) comprises, based on the total weight of the monomer (a1), at least 50 wt. % of 4,4′-dihydroxybiphenyl (biphenol), at least 50 wt. % of 2,2-bis(4-hydroxyphenyl)propane (bisphenol A) or at least 50 wt. % of 4, 4′-dihydroxydiphenyl sulfone (bisphenol S).

According to the condensation of step (a), the monomers of the reaction mixture are generally reacted concurrently. The reaction is preferably conducted in one stage. This means that the deprotonation of monomer (a1) and the condensation reaction between the monomers (a1) and (a2) takes place in a single reaction stage without isolation of the intermediate products.

According to an embodiment, the condensation is carried out in a mixture of a polar aprotic solvent and a solvent which forms an azeotrope with water. The solvent which forms an azeotrope with water includes aromatic hydrocarbons such as benzene, toluene, xylene, ethylbenzene, chlorobenzene and the like. It is preferably toluene or chlorobenzene. The azeotrope forming solvent and polar aprotic solvent are used typically in a weight ratio of from about 1:10 to about 1: 1, preferably from about 1:5 to about 1:1. Water is continuously removed from the reaction mass as an azeotrope with the azeotrope forming solvent so that substantially anhydrous conditions are maintained during the polymerization. The azeotrope-forming solvent, for example, chlorobenzene, is removed from the reaction mixture, typically by distillation, after the water formed in the reaction is removed leaving the PAES dissolved in the polar aprotic solvent.

The temperature of the reaction mixture is kept at about 150° C. to about 350° C., preferably from about 210° C. to about 300° C. for about one to 15 hours.

The inorganic constituents, for example sodium chloride or potassium chloride or excess of base, can be removed, before or after isolation of the PAES, by suitable methods such as dissolving and filtering, screening or extracting.

According to an embodiment, the amount of PAES at the end of the condensation is at least 30 wt. % based on the total weight of the PAES and the polar aprotic solvent, for example at least 35 wt. % or at least or at least 37 wt. % or at least 40 wt. %.

At the end of the reaction, the PAES polymer is separated from the other components (salts, base, . . . ) to obtain a PAES solution. Filtration can for example be used to separate the PAES polymer from the other components. The PAES solution can then be used as such for step (b) or alternatively, the PAES can be recovered from the solvent, for example by coagulation or devolatilization of the solvent.

Step (b)

Step (b) of the process of the present invention consists in dissolving the PAES from step (a) in a polar solvent S_{A}. By “dissolving the PAES in a polar solvent S_{A}”, it is also understood that the PAES solution obtained from step (a) can be diluted to the desired concentration, for example when the condensation solvent of step (a) is identical to the polar solvent S_{A}.

Step (b) can take place under agitation, in order to dissolve the polymer molecules faster and limit the generation of color. An inert gaz can also be used alternatively or in complement to agitation, for the same reasons.

The solvent S_{A} may be selected from the group consisting of N-methylpyrrolidone (NMP), N-butylpyrrolidone (NBP), N,N-dimethylformamide (DMF), N,N-dimethylacetamide (DMAC), 1,3-dimethyl-2-imidazolidinone, tetrahydrofuran (THF), dimethyl sulfoxide (DMSO), chloroform, dichloromethane, chlorobenzene and sulfolane.

The solvent S_{A} is preferably NMP.

The PAES can be dissolved at a temperature ranging from room temperature up to the boiling point of the solvent, usually between 23° C. and 150° C. The PAES solution is then kept during step (b) at a temperature ranging from about 20° C. to about 100° C.

The concentration of the PAES in the solvent at the end of step (b) can range from 1 to 40 wt. %, preferentially from 2 to 20 wt. %, even more preferentially from 3 to 15 wt. %.

Step (c)

Step (c) of the process of the present invention consists in adding a non-solvent S_{B} that is miscible with S_{A} in a weight ration S_{A}/S_{B} ranging from 50/50 to 80/20 over a period of time sufficient to create two distinct phases.

According to an embodiment, the PAES solution from step (b) is placed under agitation before introducing the solvent S_{B}.

The addition of the non-solvent S_{B} to the PAES solution of step (b), i.e. polar solvent S_{A}, can take from 0.1 to 24 hours, for example from 0.5 to 10 hours, preferably less than 3 hours. The addition of the non-solvent S_{B} to the solvent S_{A} can be done step-wise (or sequentially) or it can be done at a constant rate or at a variable rate.

The solvent S_{B} may be selected from the group consisting of water, methanol, ethanol, isopropanol, n-propanol, n-butanol, isobutanol, acetone, ethylene glycol and 1,2-propanediol and 1,3-propanediol. A mixture of at least two solvents S_{B} can also be used in the process of the present invention.

The solvent S_{B} is preferably methanol.

According to another embodiment, the weight ration S_{A}/S_{B} ranges from 55/45 to 75/25, from 57/43 to 73/27, for example from 60/40 to 70/30.

The temperature of the solution during step (c) is preferably kept from about 20° C. to about 100° C., preferentially from about 20° C. to 60° C.

During the introduction of the solvent S_{B} (for example under agitation), two phases are created: a liquid phase and a second phase being either a solid or a liquid phase with a higher viscosity.

Step (d)

According to step (d), the two distinct phases can then be separated and the PAES is subsequently recovered by conventional techniques such as coagulation, solvent evaporation, and the like.

Steps (b) and (c) can be repeated several times in the preparation process of the PAES of the present invention. Preferentially however, steps (b) and (c) are performed once.

Steps (b) and (c) of the process can also be partially combined, in such a way that part of the solvent S_{B} used in step (c) can be used in step (b). According to this embodiment, part of the solvent S_{B} is mixed with the solvent S_{A} during step (b), for example just before dissolving the PAES polymer obtained in step (a). In other words, according to this embodiment, step (b) of the process of the present invention consists in dissolving the PAES from step (a) in a blend of polar solvent S_{A} and solvent S_{B}, for example in a ratio S_{A}:S_{B} ranging from 99:1 to 75:25 or from 95:5 to 80:20.

As explained above, the part material of the present invention may comprise distinct aromatic polymers. It may for example comprise two or three distinct polymers, for example one PAES according to the present invention (i.e. having a PDI of less than 1.7 and a Mn of at least 12,000 g/mol) and one poly(ether ether ketone) (PEEK) polymer. It may also comprise two distinct PAES polymers, for example a PPSU and a PSU, at least one of the PPSU or PSU being according to the present invention, that-is-to-say having a PDI of less than 1.7 and a Mn of at least 12,000 g/mol.

According to an embodiment, the part material of the present invention comprises a polymeric component which comprises:
a) from 55 to 95 wt. % of at least one poly(aryl ether ketone) (PAEK) having a weight average molecular weight (Mw) ranging from 75,000 to 150,000 g/mol, as determined by gel permeation chromatography (GPC) using phenol and trichlorobenzene (1:1) at 160° C., with polystyrene standards, and
b) from 5 to 45 wt. % of at least one poly(aryl ether sulfone) (PAES) of the invention (i.e. having a PDI of less than 1.7 and a Mn of at least 12,000 g/mol),

based on the total weight of the polymeric component of the part material.

According to another embodiment, the part material of the present invention comprises:
a polymeric component comprising:
   a) from 55 to 95 wt. %, from 57 to 85 wt. % or from 60 to 80 wt. % of at least one poly(aryl ether ketone) (PAEK) having a weight average molecular weight (Mw) ranging from 75,000 to 150,000 g/mol, for example from 82,000 to 140,000 g/mol or from 85,000 to 140,000 g/mol, as determined by gel permeation chromatography (GPC) using phenol and trichlorobenzene (1:1) at 160° C., with polystyrene standards, and
   b) from 5 to 45 wt. %, from 15 to 43 wt. % or from 20 to 40 wt. % of at least one poly(aryl ether sulfone) (PAES) of the invention (i.e. having a PDI of less than 1.7 and a Mn of at least 12,000 g/mol), based on the total weight of the polymeric component, and
from 0 to 30 wt. %, from 0.1 to 28 wt. % or from 0.5 to 25 wt. % of at least one additive selected from the group consisting of fillers, colorants, lubricants, plasticizers, flame retardant, nucleating agent and stabilizers, based on the total weight of the part material.

According to another embodiment, the part material of the present invention comprises:
a polymeric component comprising:
   a) from 51 to 95 wt. %, from 54 to 85 wt. % or from 55 to 75 wt. % of at least one poly(ether ether ketone) (PEEK) having a weight average molecular weight (Mw) ranging from 75,000 to 150,000 g/mol, for example from 82,000 to 140,000 g/mol or from 85,000 to 140,000 g/mol, as determined by gel permeation chromatography (GPC) using phenol and trichlorobenzene (1:1) at 160° C., with polystyrene standards, and
   b) from 5 to 49 wt. %, from 15 to 46 wt. % or from 25 to 45 wt. % of at least one poly(biphenyl ether sulfone) (PPSU) of the invention (i.e. having a PDI of less than 1.7 and a Mn of at least 12,000 g/mol), based on the total weight of the polymeric component, and
from 0 to 30 wt. %, from 0.1 to 28 wt. % or from 0.5 to 25 wt. % of at least one additive selected from the group consisting of fillers, colorants, lubricants, plasticizers, flame retardant, nucleating agent and stabilizers, based on the total weight of the part material.

According to yet another embodiment, the part material of the present invention comprises:
a polymeric component comprising:
   a) from 55 to 95 wt. %, from 60 to 90 wt. % or from 65 to 85 wt. % of at least one poly(ether ether ketone) (PEEK) having a weight average molecular weight (Mw) ranging from 75,000 to 150,000 g/mol, for example from 82,000 to 140,000 g/mol or from 85,000 to 140,000 g/mol, as determined by gel permeation chromatography (GPC) using phenol and trichlorobenzene (1:1) at 160° C., with polystyrene standards, and
   b) from 5 to 45 wt. %, from 10 to 40 wt. % or from 15 to 35 wt. % of at least one polysulfone (PSU) of the invention (i.e. having a PDI of less than 1.7 and a Mn of at least 12,000 g/mol),
based on the total weight of the polymeric component, and
from 0 to 30 wt. %, from 0.1 to 28 wt. % or from 0.5 to 25 wt. % of at least one additive selected from the group consisting of fillers, colorants, lubricants, plasticizers, flame retardant, nucleating agent and stabilizers, based on the total weight of the part material.

The part material of the present disclosure can be made by methods well known to the person of ordinary skill in the art. For example, such methods include, but are not limited to, melt-mixing processes. Melt-mixing processes are typically carried out by heating the polymer components above the melting temperature of the thermoplastic polymers thereby forming a melt of the thermoplastic polymers. In some embodiments, the processing temperature ranges from about 250-450° C., preferably from about 290-440° C., from about 300-430° C. or from about 310-420° C. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the part material, the components of the part material, e.g. PPSU and optionally additives, are fed to the melt-mixing apparatus and melt-mixed in that apparatus. The components may be fed simultaneously as a powder mixture or granule mixer, also known as dry-blend, or may be fed separately.

The order of combining the components during melt-mixing is not particularly limited. In one embodiment, the component can be mixed in a single batch, such that the desired amounts of each component are added together and subsequently mixed. In other embodiments, a first sub-set of components can be initially mixed together and one or more of the remaining components can be added to the mixture for further mixing. For clarity, the total desired amount of each component does not have to be mixed as a single quantity. For example, for one or more of the components, a partial quantity can be initially added and mixed and, subsequently, some or all of the remainder can be added and mixed.

Filament Material

The present disclosure also relates to a filament material comprising a polymeric component comprising a poly(aryl ether sulfone) (PAES) polymer having a number average molecular weight (Mn) of at least 12,000 g/mol and a polydispersity (PDI) of less than 1.7, wherein:
Mn is calculated by the following formula:

$$Mn = \frac{2 , 000 , 000}{{\sum }_{i} [ {EG}_{i} ]}$$

wherein [EGᵢ] is the concentration of end-groups of the PAES in μmol/g,
Mw is calculated by GPC with light scattering according to the ASTM D-4001-93, and
PDI is Mw/Mn.

This filament material is well-suited for use in a method of making a three-dimensional object.

All of the embodiments described above with respect to the part material do apply equally to the filament material.

As an example, the filament material of the disclosure may include other components. For example the filament material may comprise at least one additive, notably at least one additive selected from the group consisting of fillers, colorants, lubricants, plasticizers, stabilizers, flame retardants, nucleating agents, flow enhancers and combinations thereof.

The filament may have a cylindrical or substantially cylindrical geometry, or may have a non-cylindrical geometry, such as a ribbon filament geometry; further, filament may have a hollow geometry, or may have a core-shell geometry, with the support material of the present disclosure being used to form either the core or the shell.

When the filament has a cylindrical geometry, its diameter may vary between 0.5 mm and 5 mm, for example between 0.8 and 4 mm or for example between 1 mm and 3.5 mm. The diameter of the filament can be chosen to feed a specific FFF 3D printer. An example of filament diameter used extensively in FFF process is 1.75 mm or 2.85 mm diameter. A good control of the filament size with a reduced standard deviation can be obtained with the PPSU polymer of the present invention. Notably, the filament can have a cylindrical geometry and a diameter comprised between 0.5 and 5 mm±0.15 mm, for example between 0.8 and 4 mm±0.1 mm or for example between 1 and 3.5 mm±0.08 mm.

The filament of the present disclosure can be made from the part material by methods including, but not limited to, melt-mixing processes. Melt-mixing processes are typically carried out by heating the polymer components above the highest melting temperature and glass transition temperature of the thermoplastic polymers thereby forming a melt of the thermoplastic polymers. In some embodiments, the processing temperature ranges from about 250-450° C., preferably from about 290-440° C., from about 300-430° C. or from about 310-420° C.

The process for the preparation of the filament can be carried out in a melt-mixing apparatus, for which any melt-mixing apparatus known to the one skilled in the art of preparing polymer compositions by melt mixing can be used. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the filament, the components of the part material, i.e. at least PPSU and optionally additives, are fed to the melt-mixing apparatus and melt-mixed in that apparatus. The components may be fed simultaneously as a powder mixture or granule mixer, also known as dry-blend, or may be fed separately.

As already explained above, the order of combining the components of the material to be printed during melt-mixing is not particularly limited.

The method of making the filaments also comprises a step of extrusion, for example with a die. For this purpose, any standard molding technique can be used; standard techniques including shaping the polymer compositions in a molten/softened form can be advantageously applied, and include notably compression molding, extrusion molding, injection molding, transfer molding and the like. Extrusion molding is preferred. Dies may be used to shape the articles, for example a die having a circular orifice if the article is a filament of cylindrical geometry.

The method may comprise if needed several successive steps of melt-mixing or extrusion under different conditions.

The process itself, or each step of the process if relevant, may also comprise a step consisting in a cooling of the molten mixture.

According to an embodiment, the process for preparing the filament material, comprises the steps of:
providing at least one poly(aryl ether sulfone) (PAES) polymer according to the present invention, and
processing the PAES polymer in the form of a filament in an extruder, wherein the temperature of the filament at the extruder outlet is below 350° C., preferably below 340° C., more preferably below 330° C.

Support Material

The method of the present disclosure may also employ another polymeric component to support the 3D object under construction. This polymeric component, similar or distinct from the part material used to build a 3D object, is hereby called support material. Support material may be required during 3D printing to provide vertical and/or lateral support in the higher operating conditions required for the high-temperature part materials (e.g. PPSU requiring a processing temperature around 320-400° C.).

The support material, possibly used in the context of the present method, advantageously possesses a high melting temperature (i.e. above 260° C.), in order to resist high temperature applications. The support material may also possess a water absorption behaviour or a solubility in water at a temperature lower than 110° C., in order sufficiently swell or deform upon exposure to moisture.

According to an embodiment of the present disclosure, the method of making a 3D object using an additive manufacturing system further comprises the steps of:
providing a support material,
printing layers of a support structure from the support material, and
removing at least a portion of the support structure from the three-dimensional object.

A variety of polymeric components can be used as a support material. Notably, support material can comprise polyamides or copolyamides, such as for example the ones described in patent applications WO 2017/167691 and WO 2017/167692.

According to another embodiment, due to the easier processing at lower temperature of the PAES build material, the support material can be a lower Tm and/or lower Tg polymeric composition for example comprising polyglycolic acid (PGA), polyvinylpyrrolidone (PVP), polyvinyl alcohol (PVA), ionomers, or (meth)acrylic acid based polymers.

Applications

The present disclosure also relates to the use of a part material comprising a polymeric component comprising at least one PAES as described above, for the manufacture of three-dimensional objects using an additive manufacturing system, for example FFF, SLS or FRTP printing methods.

The present disclosure also relates to the use of a filament material comprising a polymeric component comprising at least one PAES as described above, for the manufacture of three-dimensional objects, for example using an additive manufacturing system, for example FFF, SLS, MJF or FRTP printing methods.

All of the embodiments described above with respect to the part material do apply equally to the use of the part material or the use of the filament material.

The present disclosure also relates to the use of a part material comprising a polymeric component comprising at least one PAES as described above, for the manufacture of a filament for use in the manufacture of three-dimensional objects, for example using an additive manufacturing system, for example FFF, SLS or FRTP printing methods.

The present disclosure also relates to 3D objects or 3D articles obtainable, at least in part, from the method of making 3D object(s) of the present disclosure, using the part material herein described. These 3D objects or 3D articles present an improved impact resistance, as shown in the examples of the present invention.

The 3D objects or articles obtainable by such method of making can be used in a variety of final applications. Mention can be made in particular of implantable device, dental prostheses, brackets and complex shaped parts in the aerospace industry and under-the-hood parts in the automotive industry.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

Starting Materials

The following polymers were used to prepare filaments:

PPSU #1: a poly(biphenyl ether sulfone) (PPSU) with a Mn of 15,048 g/mol and a PDI of 1.41, prepared according to the following process:

In a 4L four-neck flask fitted with a mechanical stirrer, Dean-Stark trap, condenser and nitrogen inlet, 400 g of 4,4′-biphenol, 642.57 g of 4,4′-dichlorodiphenyl sulfone and 320.64 g of potassium carbonate were placed in 2,007 g of sulfolane. A slight stream of nitrogen was applied above the reaction mixture through one of the necks of the flask with an exit through a bubbler above the condenser. The reaction mixture was stirred with an overhead mechanical agitator and warmed using an oil bath controlled at the appropriate temperature. The bath temperature increased from room temperature to 215° C. over 60 minutes and held at the reaction temperature for 4 hours.

The reaction mixture was cooled down to 150° C., diluted with 2,000 g of sulfolane, further cooled down to 100° C. and filtered.

The PPSU was then recovered by coagulation. The PPSU in sulfolane solution was poured all at the same time into a Waring blender containing a 50/50 v/v mixture of water and methanol, in order to induce precipitation. The resulting off-white solid was then isolated by filtration, and washed three times in the Waring blender with hot deionized water (70° C.) and twice with methanol with filtration between each wash.

In a 20L vessel under agitation and inerted by a nitrogen blanket were added 600 g of PPSU and 9,120 g of NMP (solvent S_{A}).

2,280 g of methanol (solvent S_{B}) was first introduced in the vessel. After dissolution under agitation at room temperature, 2,631 g of methanol (solvent S_{B}) was introduced at a rate of 111 mL/min (during about 23 min).

After 5 min agitation, the stirrer was stopped: the reaction mixture presented a viscous layer at the bottom of the flask and a liquid layer at the top.

The viscous layer was recovered by extrusion of the bottom of the flask and diluted with 1.5 L of NMP.

The PPSU is then recovered by coagulation of the diluted viscous layer. Yield: 72%.

PPSU #2: a PPSU commercialized by Solvay Specialty Polymers under the name Radel® R5600 with a Mn of 12,428 g/mol and a PDI of 2.05.

Characterization of the PPSU

Determination of the Mn by End Group Analysis

Hydroxyl Titration

Hydroxyl groups were analyzed by dissolving a sample of the polymer in 5 ml of sulfolane : monochloro benzene (50:50). 55 ml of methylene chloride was added to the solution and it was titrated with tetrabutyl ammonium hydroxide in toluene potentiometrically using Metrohm Solvotrode electrode & Metrohm 686 Titroprocessor with Metrohm 665 Dosimat. There were three possible equivalence points. The first equivalence point was indicative of strong acid. The second equivalence point was indicative of sulfonic hydroxyls. The third equivalence point was indicative of phenolic hydroxyls. Total hydroxyl numbers are calculated as a sum of phenolic and sulfonic hydroxyls.

Chlorine Analysis

Chlorine end groups were analyzed using a ThermoGLAS 1200 TOX halogen analyzer. Samples between 1 mg and 10 mg were weighted into a quartz boat and inserted into a heated combustion tube where the sample was burned at 1000° C. in an oxygen stream. The combustion products were passed through concentrated sulfuric acid scrubbers into a titration cell where hydrogen chloride from the combustion process was absorbed in 75% v/v acetic acid. Chloride entering the cell was then titrated with silver ions generated coulometrically. Percent chlorine in the sample was calculated from the integrated current and the sample weight. The resulting percent chlorine value was converted to chlorine end group concentration in micro equivalents per gram.

Methoxy End-Group Concentration

It is determined by NMR with a C₂D₂Cl₄ solvent.

The concentration of end-groups and respective calculated Mn of the PPSU described in the examples are listed in Table 1.

Determination of Mw by Light Scattering GPC

A Viscotek GPC Max with a TDA302 Triple detector array comprised of RALS (Right Angle Light Scattering), RI and Viscosity detectors was used. NMP with 0.2 w/w% LiBr at 65oC at 1.0 mL/min was run through 3 columns: a guard column (CLM1019—with a 20 k Da exclusion limit), a high Mw column (CLM1013 exclusion of 10 MM Daltons relative to Poly Styrene), and a low Mw column (CLM1011—exclusion limit of 20 k Daltons relative to PS). Calibration was done with a single, mono-disperse polystyrene standard of ˜100 k Da.

The samples were a concentration of about 2 mg/mL in NMP/LiBr. The Mw of the PPSU described in the examples are listed in Table 1.

TABLE 1

| | —Cl | —OH | —OCH₃ | Mn | Mw | |
|---|---|---|---|---|---|---|
| Polymer | (μmol/g) | (μmol/g) | (μmol/g) | (g/mol) | (g/mol) | PDI |
| PPSU #1 | 132.9 | 0 | 0 | 15,048 | 21,217 | 1.41 |
| (inv) | | | | | | |
| PPSU #2 | 112.7 | 3.5 | 44 | 12,428 | 25,477 | 2.05 |
| (comp) | | | | | | |

Filament Preparation

PPSU #1 was extruded into strand that were pelletized on a Brabender® Intelli-Torque Plasti-Corder® Torque Rheometer extruder equipped with a 0.75″ 32 L/D general purpose single screw. The four heating zone were regulated at 180-270-300-300° C. The pellets were then extruded into a filament of diameter of 1.75 mm very easily at low processing temperature using a Brabender® Intelli-Torque Plasti-Corde® Torque Rheometer extruder equipped with a 0.75″ 32 L/D general purpose single screw, a filament head adapter, a 2.5-mm nozzle and ESI-Extrusion Services downstream equipment comprising a cooling tank, a belt puller, and a Dual Station Coiler. A Beta LaserMike® DataPro 1000 was used to monitor filament dimensions. The melt strand was cooled with air. The Brabender® zone set point temperatures were as follows: zone 1, 180° C.; zone 2, 270° C.; zones 3, 300° C. and 4, 300° C., providing a melt temperature of 322° C., which is the temperature measured at the outlet of the extruder for quality control purpose. A melt temperature of 322° C. at the outlet of the extruder can be considered as a low temperature for processing PPSU, compared to commercial PPSU grades for example, thereby demonstrating one of the benefit of the low viscosity of PPSU #1. The Brabender® speed ranged from 30 to 50 rpm and the puller speed from 23 to 37 fpm.

1.75 mm diameter filaments of PPSU #2 was prepared similarly but with Brabender® zone set point temperatures that were much higher in order to obtain filaments of acceptable quality: 350-340-330-330° C., providing a melt temperature of 360° C. (temperature measured at the outlet of the extruder).

Fused Filament Fabrication Bars (FFF Bars)

Test bars (i.e. ASTM D638 Type V bars) were printed from the above filaments of 1.75 mm in diameter on a Hyrel 16A 3D printer equipped with a 0.5 mm diameter nozzle. The extruder temperature was 400° C. and the bed temperature was 200° C. Bars were oriented in the XY direction on the build platform during printing. Test bars were printed with a 2 mm-wide brim and three perimeters. The tool path was a cross-hatch pattern with a 45° angle with respect to the long axis of the part. The speed of the nozzle for deposition of the first layer was 35 mm/sec; otherwise, speed for the next layers was 35 mm/s. The first layer height in each case was 0.4 mm, with subsequent layers deposited at 0.1 mm height and 100% fill density.

Mechanical Properties

Notched impact strength was determined according to the ASTM D256 method using a 2-ftlb hammer. Results are shown in Table 2 below.

Tensile strength and modulus were determined according to the ASTM D638 method with Type V bars. The results for both PPSU#1 and PPSU #2 were comparable (not shown below).

TABLE 2

| | Impact strength |
|---|---|
| Polymer | (ft-lb/in) |
| PPSU #1 | 3.55 ± 0.955 |
| (inv) | |
| PPSU #2 | 2.03 ± 0.206 |
| (comp) | |

1. A method for manufacturing a three-dimensional (3D) object with an additive manufacturing system, the method comprising a step comprising printing layers of the 3D object from a part material comprising a polymeric component, said polymeric component comprising at least one poly(aryl ether sulfone) (PAES) polymer having a number average molecular weight (Mn) of at least 12,000 g/mol and a polydispersity (PDI) of less than 1.7, wherein:
Mn is calculated by the following formula:
$$Mn = \frac{2 , 000 , 000}{{\sum }_{i} [ {EG}_{i} ]}$$
wherein [EGᵢ] is the concentration of end-groups of the PAES in pmol/g,
Mw is calculated by GPC with light scattering according to the ASTM D-4001-93, and
PDI is Mw/Mn,
wherein the PAES comprises at least 50 mol. % (based on the total number of moles in the polymer) of recurring units (R_{PAES}) of formula (K): 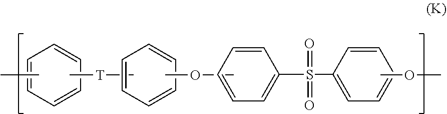
where
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6.

2. The method of claim 1, wherein the step of printing layers further comprises extruding the part material.

3. The method of claim 1, wherein the part material is in the form of a filament having a cylindrical geometry and a diameter comprised between 0.5 and 5 mm±0.15 mm.

4. The method of claim 1, wherein the PAES polymer comprises at least 90 mol. % of recurring units (R_{PAES}) of formula (K).

5. The method of claim 1, wherein:
the PDI of the PAES is less than 1.6,
the Mn of the PAES is at least 13,000 g/mol, and/or
the Mw of the PAES is less than 24,000 g/mol.

6. The method of claim 1, wherein the PAES is selected from the group consisting of a polysulfone (PSU), a polyethersulfone (PES) and a polyphenylsulfone (PPSU).

7. A filament material for 3D printing, the filament material comprising a polymeric component comprising a poly(aryl ether sulfone) (PAES) polymer having a number average molecular weight (Mn) of at least 12,000 g/mol and a polydispersity (PDI) of less than 1.7, wherein:
Mn is calculated by the following formula:
$$Mn = \frac{2 , 000 , 000}{{\sum }_{i} [ {EG}_{i} ]}$$
wherein [EGᵢ] is the concentration of end-groups of the PAES in μmol/g,
Mw is calculated by GPC with light scattering according to the ASTM D-4001-93, and
PDI is Mw/Mn,
wherein the PAES comprises at least 50 mol. % (based on the total number of moles in the polymer) recurring units (R_{PAES}) of formula (K): 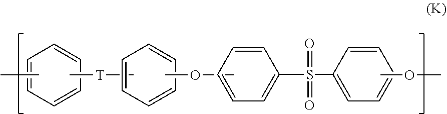
wherein
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6.

8. The filament material of claim 7, wherein the polymeric component comprises at least 80 wt. % of the PAES polymer, based on the total weight of polymeric component of the filament.

9. The filament material of claim 7, further comprising from 0.1 to 30 wt. % of an additive selected from the group consisting of fillers, colorants, lubricants, plasticizers, flame retardants, nucleating agents, flow enhancers and stabilizers.

10. The filament material of claim 7, having a diameter comprised between 1 and 3.5 mm±0.15 mm.

11. The filament material of claim 7, for use as a deposition material in a fused filament fabrication (FFF) printer.

12. A process for preparing a filament material, the process comprising:
providing at least one poly(aryl ether sulfone) (PAES) polymer having a number average molecular weight (Mn) of at least 12,000 g/mol and a polydispersity (PDI) of less than 1.7, wherein:
Mn is calculated by the following formula:
$$Mn = \frac{2 , 000 , 000}{{\sum }_{i} [ {EG}_{i} ]}$$
wherein [EGᵢ] is the concentration of end-groups of the PAES in μmol/g,
Mw is calculated by GPC with light scattering according to the ASTM D-4001-93, and
PDI is Mw/Mn, and
processing the PAES polymer in the form of a filament in an extruder, wherein the temperature of the filament at the extruder outlet is below 350° C.,
wherein the PAES comprises at least 50 mol. % (based on the total number of moles in the polymer) recurring units (R_{PAES}) of formula (K): 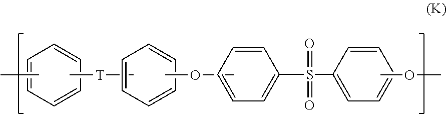
where
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6.

13. A method for manufacturing a three-dimensional (3D) object, the method comprising using a part material comprising a polymeric component comprising a poly(aryl ether sulfone) (PAES) polymer having a number average molecular weight (Mn) of at least 12,000 g/mol and a polydispersity (PDI) of less than 1.7, wherein:
Mn is calculated by the following formula:
$$Mn = \frac{2 , 000 , 000}{{\sum }_{i} [ {EG}_{i} ]}$$
wherein [EGᵢ] is the concentration of end-groups of the PAES in pmol/g,
Mw is calculated GPC with light scattering according to the ASTM D-4001-93, and
PDI is Mw/Mn,
to manufacture a three-dimensional (3D) object using an extrusion-based additive manufacturing system, wherein the PAES comprises at least 50 mol. % (based on the total number of moles in the polymer) recurring units (R_{PAES}) of formula (K): 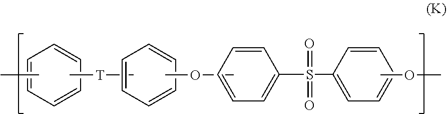
where
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6.

14. A method for manufacturing a filament for use in the manufacture of three-dimensional objects, the method comprising using a part material comprising a polymeric component comprising a poly(aryl ether sulfone) (PAES) polymer having a number average molecular weight (Mn) of at least 12,000 g/mol and a polydispersity (PDI) of less than 1.7, wherein:
Mn is calculated by the following formula:
Mn=Σᵢ[EGᵢ]/2,000,000
wherein [EGᵢ] is the concentration of end-groups of the PAES in pmol/g,
Mw is calculated by GPC with light scattering according to the ASTM D-4001-93, and
PDI is Mw/Mn,
wherein the PAES comprises at least 50 mol. % (based on the total number of moles in the polymer) recurring units (R_{PAES}) of formula (K): 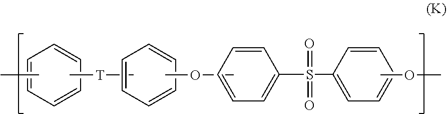
where
T is selected from the group consisting of a bond, —CH₂—, —O—, —SO₂—, —S—, —C(O)—, —C(CH₃)₂—, —C(CF₃)₂—, —C(═CCl₂)—, —C(CH₃)(CH₂CH₂COOH)—, —N═N—, —C(R′)(R″)—, —R′C═CR″—, —(CH₂)ₘ—, —(CF₂)ₘ—, an aliphatic, linear or branched divalent group, having 1-6 carbon atoms, and combinations thereof
R′ and R″, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium,
m is an integer from 1 to 6,
to manufacture a filament.

15. Three-dimensional (3D) objects made by the method of claim 1.
